(19) United States
(12) Patent Application Publication
(10) Pub. No.: US 2013/0294231 A1
(43) Pub. Date: Nov. 7, 2013

(54) METHOD OF HIGH-SPEED SWITCHING FOR NETWORK VIRTUALIZATION AND HIGH-SPEED VIRTUAL SWITCH ARCHITECTURE

(71) Applicant: Electronics and Telecommunications Research Institute, (US)

(72) Inventors: Kodirov NODIR, Daejeon (KR); Doyeon KIM, Daejeon (KR); Tae Ho LEE, Daejeon (KR); Jae Gi LEE, Daejeon (KR); SangSik YOON, Daejeon (KR); Taesang CHOI, Daejeon (KR)

(73) Assignee: Electronics and Telecommunications Research Institute, Daejeon (KR)

(21) Appl. No.: 13/648,468

(22) Filed: Oct. 10, 2012

(30) Foreign Application Priority Data
May 2, 2012 (KR) 10-2012-0046515

(51) Int. Cl. H04L 12/56; H04L 12/24

(52) U.S. Cl. 370/230; 370/392

(57) ABSTRACT

A virtual switch for providing a network virtualization service and a high-speed switching method of an input packet are provided. A packet is efficiently transmitted at a high speed using information of the input packet between a physical interface and a logical interface or between logical interfaces.

### CROSS-REFERENCE TO RELATED APPLICATION

This application claims priority to and the benefit of Korean Patent Application No. 1 0-201 2-004651 5 filed in the Korean Intellectual Property Office on May 2, 2012, the entire contents of which are incorporated herein by reference.

### BACKGROUND OF THE INVENTION

(a) Field of the Invention

The present invention relates to a method of high-speed switching of a packet for network virtualization and a virtual switch for high-speed switching.

(b) Description of the Related Art

Cloud computing is an environment where a user performs desired work by remote control through a central system using various terminals such as a PC or a mobile phone, wherein the central system stores data and software that individually stored in a personal computer (PC) or a server of a corporation. That is, a plurality of users may receive enormous informational technology (IT) ability as one service using Internet technology.

Cloud computing is similar to utility computing or software as a service (SaaS) in an aspect that a cost is paid by use amount of a computing resource at a user side, and is similar to a concept of grid computing in an aspect that it provides use like one computing resource by combining several distributed computing resources at a service provider side. That is, cloud computing is a combination of grid computing in a technical aspect and utility computing as an accounting model.

In such a cloud service, because operation and management can be efficiently performed and less construction cost is required, providers of the cloud service regard the cloud service as an important future service, and particularly, a cloud data center service is a field in which most IT providers show interest.

In a general cloud data center network, each server of a data center is mounted in a rack to form a final server group, and all servers of the server group are connected through a top-of-rack (ToR) switch. Each server supports an operating system (OS) and a virtual machine (VM) virtualization using a hypervisor function, and a VM virtual switch for connection between internal VMs exists at each server.

A plurality of ToR switches form a layer 2 (L2) switch connection through an upper-level aggregation switch (AS), a plurality of ASs are connected to an upper-level access router (AR), and a plurality of ARs are connected again to an upper-level border router (BR), and thus the plurality of ARs and the plurality of BRs form a layer 3 (L3) router connection. Finally, as the plurality of BRs are connected to the Internet backbone, a cloud data center network may be formed.

In order to provide a virtual network to users based on a physical network resource such as the data center network, network virtualization technology is essentially necessary. In network virtualization, a control plane and a transmission plane should be separated, and interface virtualization and virtualization of a transmission engine is requested.

First of all, a high performance virtual switch for packet transfer through a virtual interface between internal virtual engines as well as packet transfer between a physical interface and a virtual interface performs a central function in a virtualized network environment.

In general, a virtual switch for network virtualization is embodied using a multi-core network processor unit (multi-core NPU), and in this case, the embodied virtual switch should be able to transfer a packet that is input from a physical interface to the internal virtual engine without damage and should transmit a packet without damage through a virtual interface between virtual engines, and thus technology that designs a virtual switch for embodying high-speed switching of a packet is very important.

### SUMMARY OF THE INVENTION

The present invention has been made in an effort to provide a method of high-speed switching a packet between a physical interface and a virtual engine, and a virtual switch having a high-speed switching function in a general commercially available network processor unit when designing a virtual switch that is centrally requested for network virtualization.

An exemplary embodiment of the present invention provides a method of switching a packet in a network virtualization switch. The method includes: receiving the packet; classifying the packet into a packet to transfer to a logical interface and a packet to transfer to a physical interface; mapping, when the packet is a packet to transfer to the logical interface, the packet to one logical interface of a plurality of logical interfaces using a logical interface mapping table; changing a media access control (MAC) address of the packet to an address of the mapped logical interface; transferring the packet to a virtual forwarding element (VFE) corresponding to the mapped logical interface;

mapping the packet that is transferred to the VFE to the physical interface using a physical interface mapping table; and converting the logical interface address of the packet to a MAC address and transmitting the packet to the mapped physical interface.

The method may further include transmitting the packet to the physical interface, when the packet is classified to be transmitted to the physical interface.

The method may further include: at the mapping of the packet that is transferred to the VFE to the physical interface, if a physical interface corresponding to the packet does not exist, determining whether a logical interface corresponding to the packet exists using a logical interface lookup table; and transmitting the packet to the corresponding logical interface.

The method may further include removing the packet if a logical interface corresponding to the packet does not exist.

The method may further include storing, when the packet is a packet to transmit to the logical interface, a reference value of the packet at a buffer, wherein the mapping of the packet to one logical interface may include reading the packet based on the reference value.

The method may further include storing the packet that is changed to the logical interface address at the buffer, wherein the transferring of the packet to a VFE may include transferring the packet that is stored at the buffer.

The mapping of the packet that is transferred to the VFE to the physical interface may include storing the packet that is transferred to the VFE at the buffer, and mapping the packet that is stored at the buffer to the physical interface using the physical interface mapping table.

Another embodiment of the present invention provides a network virtualization switch that switches a packet for network virtualization. The network virtualization switch includes: a physical interface unit that transmits and receives a packet to and from an outer node and that includes a plurality of physical interfaces; a plurality of VFEs that each have a logical interface; an input packet processor that classifies a packet that the physical interface unit receives into a packet to transfer to the logical interface and a packet to transfer to the physical interface unit; a physical packet switching (PPS) unit that maps a packet to be transferred to the logical interface unit to one logical interface of a plurality of logical interfaces using a logical interface mapping table and that converts a MAC address of the packet to the mapped logical interface address; a logical output processor that transfers the packet to a VFE corresponding to the mapped logical interface; a logical packet switching (LPS) unit that maps the packet that is transferred from the VFE to a physical interface using a physical interface mapping table and that converts a logical interface address of the packet to a MAC address; and a physical output processor that transmits the packet to the mapped physical interface.

The network virtualization switch may further include an upper-level virtual switch policy manager (VSPM) and a virtual switch management interface (VSMI) that perform communication for performing a policy of the virtual switch.

The input packet processor may perform a search function of virus traffic and an identification function of a precision application service by searching for whether a specific signature exists in contents of an input packet using a deep packet inspection (DPI) dedicated processor.

The input packet processor may perform a function of searching for and intercepting abnormal traffic.

The physical output processor may perform a rate-limit function based on a flow or destination Internet protocol (IP) address and a traffic management function for guaranteeing a quality of service (QoS).

### BRIEF DESCRIPTION OF THE DRAWINGS

FIG. 1 is a diagram illustrating a cloud data center network according to an exemplary embodiment of the present invention.

FIG. 2 is a diagram illustrating a virtual switch according to an exemplary embodiment of the present invention.

FIG. 3 is a flowchart illustrating a processing process of a packet that is input to a virtual switch according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a virtual switch for virtualization of a cloud network and a method of switching the same according to an exemplary embodiment of the present invention will be described in detail with reference to the drawings.

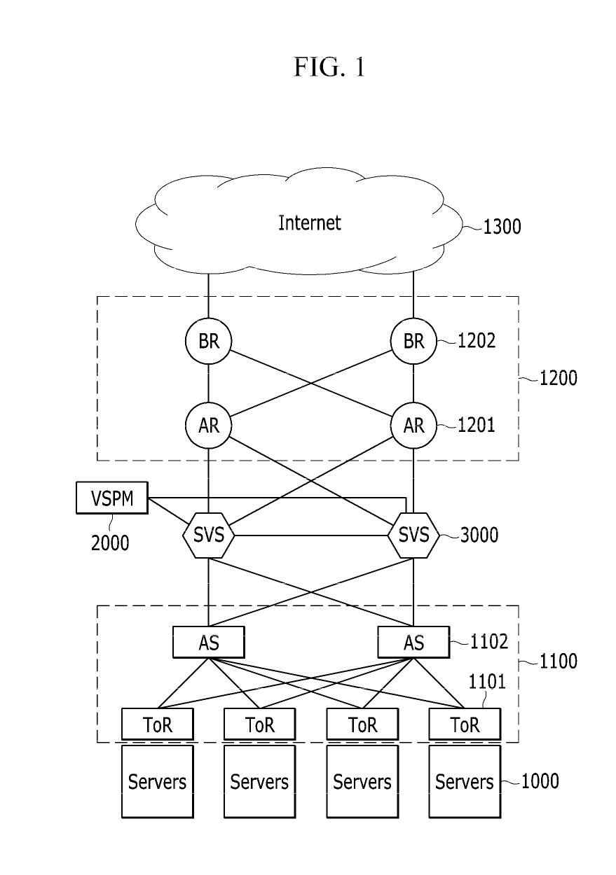

FIG. 1 is a diagram illustrating a cloud data center network according to an exemplary embodiment of the present invention.

Referring to FIG. 1, a virtual switch 3000 according to an exemplary embodiment of the present invention is positioned between a layer 2 (L2) switch 1100 and a layer 3 (L3) router 1200 of a cloud network to perform a smart virtual switch (SVS) function for cloud virtual servers, thereby enabling execution of a network virtualization service.

In this case, a network operator sets a policy to the virtual switch 3000 through a virtual switch policy manager (VSPM) 2000, thereby enabling performance of various policy operations of a network virtualization service.

In a cloud data center network, each of servers 1000 is mounted in a rack to form a final server group, and all servers 1000 of the server group are connected through a top-of-rack (ToR) switch 1101. Each server 1000 supports an OS and a virtual machine (VM) virtualization using a hypervisor function, and a VM virtual switch for connecting internal VMs exists in each server.

A plurality of ToR switches 1101 form the L2 switch 1100 through an upper-level aggregation switch (AS) 1102. A plurality of upper-level access routers 1201 (AR) and a plurality of upper-level border routers 1202 (BR) that are connected to the plurality of ARs form the L3 router connection. Finally, as a plurality of BRs are connected to the Internet backbone 1300, a cloud data center network can be formed.

As described above, by additionally installing the virtual switch 3000 according to an exemplary embodiment of the present invention between the L2 switch 1100 and the L3 router 1200 of a cloud network for supporting an existing virtualization service, a network provider can use cloud network equipment in which only a software-based virtual switch is installed and thus an effect of cost reduction can be obtained, and a performance problem of a software-based virtual switch can be overcome.

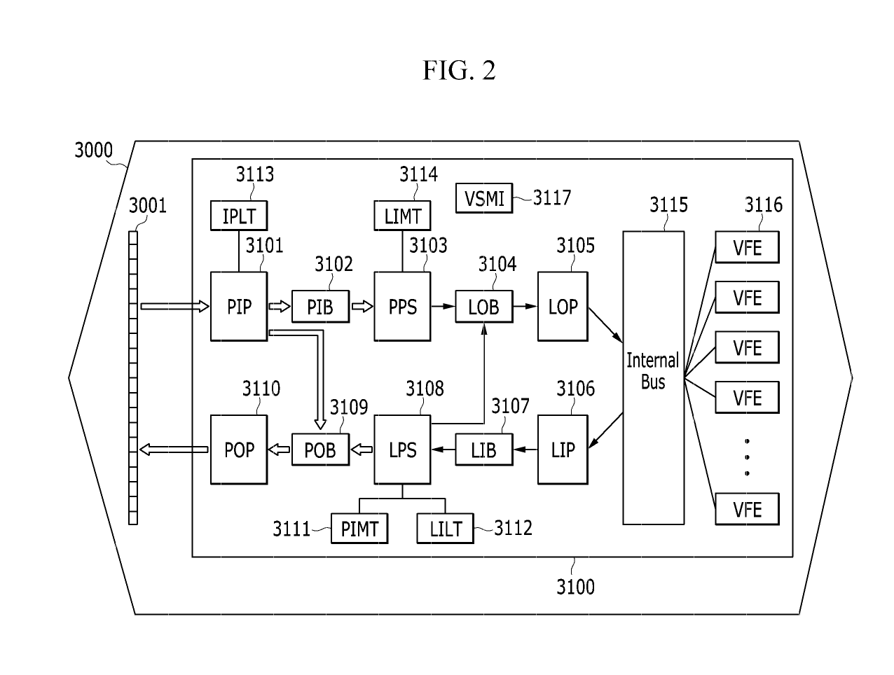

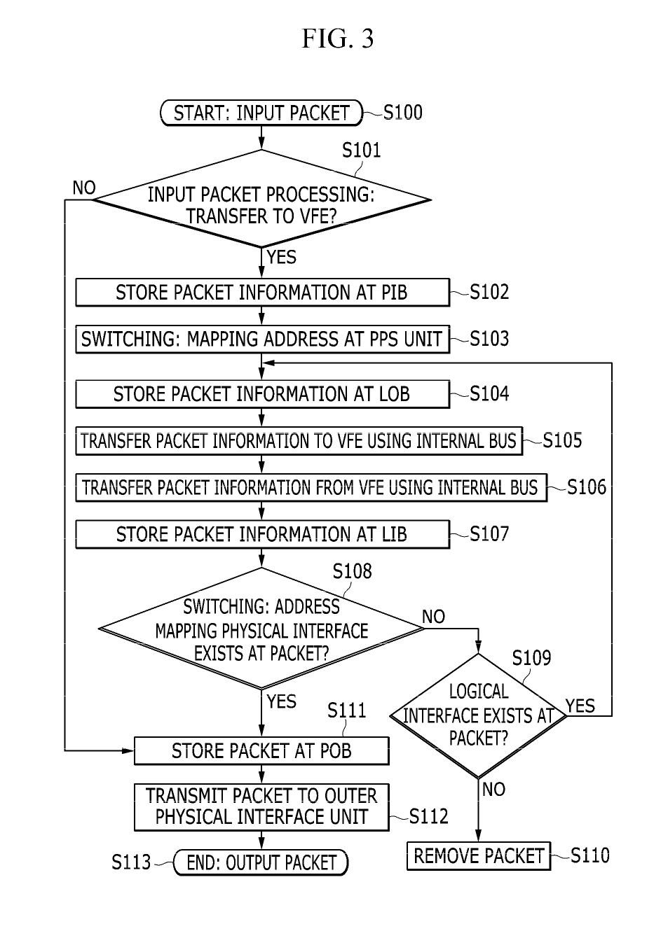

FIG. 2 is a diagram illustrating a virtual switch according to an exemplary embodiment of the present invention, and FIG. 3 is a flowchart illustrating a process of processing a packet that is input to a virtual switch.

Referring to FIG. 2, the virtual switch 3000 includes a physical interface unit 3001 and a network processor unit 3100.

The physical interface unit 3001 is physically connected to the L2 switch 1100 and the L3 router 1200 of a cloud network.

The network processor unit 3100 is connected to the physical interface unit 3001 to receive input of a packet and to process the packet, and outputs the processed packet through the physical interface unit 3001.

The network processor unit 3100 includes a virtual switch management interface (VSMI) 3117 that is connected to a virtual switch policy manager 2000 and enables the virtual switch 3000 to be operated according to a policy that is set by a network operator. For example, a network operator may search for virus traffic or identify a precision application service by applying a policy that searches for contents of a packet to a virtual switch.

Further, the network processor unit 3100 includes an internal bus 3115 and a plurality of virtual forwarding elements (VFE) 3116 that are connected to a logical interface to forward a packet.

Hereinafter, a process of classifying and processing a packet that is input to the virtual switch 3000 in the network processor unit 3100 via the physical interface unit 3001 and outputting the packet from the virtual switch 3000 via the physical interface unit 3001 will be described in detail with reference to FIG. 3.

Referring to FIG. 3, the physical interface unit 3001 of a network receives an input of a packet from one of the L2 switch 1100 and the L3 router 1200, and transfers the packet to the network processor unit 3100 (S100).

The packet is transferred to an input packet processor (PIP) 3101 of the network processor unit 3100.

The input packet processor 3101 determines whether the input packet is a packet to be transferred to the VFE 3116 corresponding to a logical interface or a packet to be transmitted to the physical interface unit 3001 using an input packet lookup table (IPLT) 3113 (S101).

The IPLT 3113 generally includes 5 tuple conditions (source IP, destination IP, TCP/UDP source port, TCP/UDP destination port, and IP protocol) and a set of processing actions of a corresponding packet, and in order to perform a lookup function for more precise input packet processing, the IPLT 3113 includes 10 tuple conditions (input port, source MAC address, destination MAC address, Ethernet type, VLAN ID, and the 5 tuple).

The input packet processor 3101 searches for an access control list (ACL) using the IPLT 3113 and processes the input packet.

In this case, a packet to transfer to the physical interface unit 3001 is stored at a physical output buffer (POB) 3109 (S111). If the input packet is a packet to transfer to the VFE 3116 corresponding to a logical interface at step S101, the input packet is stored at a physical input buffer (FIB) 3102 (S102).

In this case, when an entire packet is actually stored, the switching speed of the virtual switch 3000 may be remarkably deteriorated and thus only reference values of the packet are stored at the PIB 3102, whereby high-speed switching performance of the virtual switch 3000 can be obtained.

After a reference value of the packet is stored at the PIB 3102, the reference value is used in various classification and processing processes in the network processor unit 3100.

A memory may be used for performing storage and search of the IPLT 3113, and in this case, a high speed memory that is included in the network processor unit 3100 may be used, and an dedicated ternary content addressable memory (TCAM) may be used for guaranteeing high-speed switching performance.

In addition, the input packet processor 3101 performs a function of searching for virus traffic and identifying a precision application service by searching for a specific signature that is included in contents (payload) of the packet.

In this case, the input packet processor 3101 performs signature search performance at a high speed using an auxiliary processor chip such as a deep packet inspection (DPI) dedicated field programmable gate array (FPGA) or an application specific integrated circuit (ASIC).

Further, for system stability of the virtual switch 3000, the input packet processor 3101 may perform a function of searching for and intercepting abnormal traffic such as media access control (MAC) flooding or distributed denial of service (DDoS).

By performing the above function, stability of a commercially available cloud network virtualization service is secured and availability thereof can be guaranteed.

In this case, when a network operator applies a policy that performs a search function of a specific signature of the input packet processor 3101 and an interception function through the virtual switch management interface 3117, the search function and the interception function can be performed.

After the above function is performed in the input packet processor 3101, the packet is transferred to a physical packet switching (PPS) unit 3103, and by mapping the packet to a logical interface, the PPS unit 3103 switches the packet to a logical interface of the corresponding VFE 3116 (S103).

In this case, the PPS unit 3103 changes a MAC address of the packet to a logical interface address of the VFE 3116 using a logical interface mapping table (LIMT) 3114, thereby performing a switching function of a packet. At this time, the packet that is switched in the PPS unit 3103 may be a reference value of the packet.

Thereafter, a packet having a MAC address that is changed to an address of a logical interface is stored at a logical output buffer (LOB) 3104 (S104).

Thereafter, a logical output processor (LOP) 3105 transfers the packet that is stored at the logical output buffer 3104 to the VFE 3116 that is connected to the internal bus 3115 and the logical interface using the internal bus 3115 (S105). In this case, a packet that is transferred from the logical output processor 3105 to the VFE 3116 may be a reference value of the packet.

The VFE 3116 performs a function of a virtual router for transferring the packet to each server 1000. The VFE 3116 performs a virtual interface setting function, an address resolution protocol (ARP) function, an IP forwarding lookup function, or a virtual interface packet transfer function. Further, the VFE 3116 may additionally perform a random IP middle box function such as flow monitoring, meta information collection, tunneling, or encoding and decoding using a VM virtualization platform.

The packet that is forwarded from the VFE 3116 is transferred to a logical input processor (LIP) 3106 via the internal bus 3115 (S106).

The LIP 3106 stores the packet that it receives from the internal bus 3115 at a logical input buffer (LIB) 3107 (S107). In this case, the packet that is transferred to the LIP 3106 and that is stored at the logical input buffer 3107 may be a reference value of the packet.

Thereafter, a logical packet switching (LPS) unit 3108 determines whether the packet that is stored at the logical input buffer 3107 is a packet to be transferred to an external physical interface using a physical interface mapping table (PIMT) 3111, i.e., whether the physical interface exists at the packet (S108).

If the physical interface does not exist at the packet, the LPS unit 3108 does not store the packet at the POB 3109, and the LPS unit 3108 determines whether the packet is a packet to be transferred to a logical interface using a logical interface lookup table (LILT) 3112, i.e., whether the logical interface exists at the packet (S109).

If the logical interface exists at the packet, the packet should be again transmitted to the logical interface and thus the packet is stored at the logical output buffer 3104 (S104), is moved to the internal bus 3115 by the logical output processor 3105, and is transmitted to the VFE 3116. In this case, the packet that is determined to be in the LPS unit 3108 may be a reference value of the packet.

However, even if the logical interface lookup table 3112 is searched for, if the logical interface does not exist at the packet at step S109, the packet is removed (S110).

If the packet is a packet to be transferred to the physical interface unit 3001 by searching for the PIMT 3111 at step S108, an additional function such as conversion of a MAC address and insertion of a tunneling header is performed, and then the packet is stored at the POB 3109 (S111).

In this case, when the physical interface mapping table 3111 is searched for using a reference value of the packet, after an additional function such as conversion of a MAC address and insertion of a tunneling header is performed, the reference value of the packet is coupled to the packet and is stored at the POB 3109.

Thereafter, a physical output processor (POP) 3110 transmits the packet that is stored at the POB 3109 to the physical interface unit 3001 (S112).

In this case, the physical output processor 3110 additionally performs a flow or destination IP address-based rate limit function and a traffic manager (TM) function for guaranteeing quality of service (QoS).

Finally, when the packet is output from the virtual switch 3000 via the physical interface unit 3001 (S113), a processing process of the packet that is input to the virtual switch 3000 is terminated.

In this way, according to an exemplary embodiment of the present invention, the packet that is input to the virtual switch may be transferred to the physical interface and/or the logical interface without damage, and as some (e.g., a reference value of the packet) of an entire packet is used, when processing the packet, high-speed switching performance can be obtained.

Further, the virtual switch performs processing of the input packet using a high speed memory within a network processor unit or using a ternary content addressable memory (TCAM), thereby obtaining high-speed switching performance.

Further, according to another exemplary embodiment of the present invention, by applying a policy that searches for contents of the packet to a virtual switch, virus traffic can be searched for or a precision application service can be identified, and by processing a packet using a high speed memory within a network processor unit or using an dedicated TCAM, high-speed switching performance can be obtained.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from the description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of switching a packet in a network virtualization switch, the method comprising:
receiving the packet;
classifying the packet into a packet to transfer to a logical interface and a packet to transfer to a physical interface;
when the packet is a packet to transfer to the logical interface,
mapping the packet to one logical interface of a plurality of logical interfaces using a logical interface mapping table;
changing a media access control (MAC) address of the packet to an address of the mapped logical interface;
transferring the packet to a virtual forwarding element (VFE) corresponding to the mapped logical interface;
mapping the packet that is transferred to the VFE to the physical interface using a physical interface mapping table; and
converting the logical interface address of the packet to a MAC address and transmitting the packet to the mapped physical interface.

2. The method of claim 1, further comprising transmitting the packet to the physical interface,
when the packet is classified to be transmitted to the physical interface.

3. The method of claim 1, further comprising:
at the mapping of the packet that is transferred to the VFE to the physical interface, if a physical interface corresponding to the packet does not exist,
determining whether a logical interface corresponding to the packet exists using a logical interface lookup table; and
transmitting the packet to the corresponding logical interface.

4. The method of claim 3, further comprising removing the packet if a logical interface corresponding to the packet does not exist.

5. The method of claim 1, further comprising storing, when the packet is a packet to transmit to the logical interface, a reference value of the packet at a buffer,
wherein the mapping of the packet to one logical interface comprises reading the packet based on the reference value.

6. The method of claim 1, further comprising storing the packet that is changed to the logical interface address at the buffer,
wherein the transferring of the packet to a VFE comprises transferring the packet that is stored at the buffer.

7. The method of claim 1, wherein the mapping of the packet that is transferred to the VFE to the physical interface comprises:
storing the packet that is transferred to the VFE at the buffer; and
mapping the packet that is stored at the buffer to the physical interface using the physical interface mapping table.

8. A network virtualization switch, comprising:
a physical interface unit that transmits and receives a packet to and from an outer node and that comprises a plurality of physical interfaces;
a plurality of virtual forwarding elements (VFEs) that each have a logical interface;
an input packet processor that classifies a packet that the physical interface unit receives into a packet to transfer to the logical interface and a packet to transfer to the physical interface unit;
a physical packet switching (PPS) unit that maps a packet to be transferred to the logical interface unit to one logical interface of a plurality of logical interfaces using a logical interface mapping table and that converts a media access control (MAC) address of the packet to the mapped logical interface address;
a logical output processor that transfers the packet to a VFE corresponding to the mapped logical interface;
a logical packet switching (LPS) unit that maps the packet that is transferred from the VFE to a physical interface using a physical interface mapping table and that converts a logical interface address of the packet to a MAC address; and
a physical output processor that transmits the packet to the mapped physical interface.

9. The network virtualization switch of claim 8, further comprising an upper-level virtual switch policy manager (VSPM) and a virtual switch management interface (VSMI) that perform communication for performing a policy of the virtual switch.

10. The network virtualization switch of claim 8, wherein the input packet processor performs a search function of virus traffic and an identification function of a precision application service by searching for whether a specific signature exists in contents of an input packet using a deep packet inspection (DPI) dedicated processor.

11. The network virtualization switch of claim 8, wherein the input packet processor performs a function of searching for and intercepting abnormal traffic.

12. The network virtualization switch of claim 8, wherein the physical output processor performs a rate-limit function based on a flow or destination Internet protocol (IP) address and a traffic management function for guaranteeing a quality of service (QoS).
